(19) United States
(12) Patent Application Publication
(10) Pub. No.: US 2022/0234389 A1
(43) Pub. Date: Jul. 28, 2022

(54) MOTORCYCLE TIRE

(71) Applicant: Sumitomo Rubber Industries, Ltd., Kobe-shi (JP)

(72) Inventor: Chihiro KOBORI, Kobe-shi (JP)

(73) Assignee: Sumitomo Rubber Industries, Ltd., Kobe-shi (JP)

(21) Appl. No.: 17/568,816

(22) Filed: Jan. 5, 2022

(30) Foreign Application Priority Data
Jan. 26, 2021 (JP) 2021-010530

(51) Int. Cl. B60C 9/06; B60C 9/22

(52) U.S. Cl. CPC B60C 9/06; B60C 2200/10; B60C 9/22

(57) ABSTRACT

A motorcycle tire includes a tread portion between a pair of tread edges, a pair of sidewall portions, a pair of bead portions, and a carcass having a bias structure and extending between the bead portions. The tread portion, when a tread development width between the pair of tread edges is equally divided into five regions, includes a crown region, a pair of shoulder regions and a pair of middle regions located between the crown region and each of the shoulder regions. The carcass includes a plurality of carcass cords, and an angle θs with respect to a tire circumferential direction of at least one of the plurality of carcass cords in the shoulder regions is greater than an angle θc with respect to the tire circumferential direction of at least one of the plurality of carcass cords in the crown region.

### RELATED APPLICATIONS

This application claims the benefit of foreign priority to Japanese Patent Application No. JP2021-010530, filed Jan. 26, 2021, which is incorporated by reference in its entirety.

### FIELD OF THE INVENTION

The present disclosure relates to a motorcycle tire.

### BACKGROUND OF THE INVENTION

The Patent document 1 below discloses a motorcycle bias tire. The tire includes a bias carcass having carcass cords which are inclined with respect to the tire circumferential direction and a band layer disposed on the carcass in the tread portion. The tire has been expected to reduce the tire weight and improve steering stability by the carcass ply and the band layer.

### Patent Document

[Patent document 1] Japanese Unexamined Patent Application Publication 2000-185511

### SUMMARY OF THE INVENTION

Motorcycle tires including the carcass with a bias structure as described above tend to have a small camber thrust when turning at a relatively large camber angle. Thus, improvement in turning performance has been required.

The present disclosure has been made in view of the above circumstances and has a major object to provide a motorcycle tire having a bias carcass capable of exhibiting superior turning performance.

In one aspect of the present disclosure, a motorcycle tire includes a tread portion between a pair of tread edges, a pair of sidewall portions, a pair of bead portions, and a carcass having a bias structure and extending between the pair of bead portions. The tread portion, when a tread development width between the pair of tread edges of the tread portion is equally divided into five regions, includes a central crown region, a pair of shoulder regions including the pair of tread edges and a pair of middle regions located between the crown region and each of the shoulder regions. The carcass includes a plurality of carcass cords, and an angle θs with respect to a tire circumferential direction of at least one of the plurality of carcass cords in the shoulder regions is greater than an angle θc with respect to the tire circumferential direction of at least one of the plurality of carcass cords in the crown region.

### BRIEF DESCRIPTION OF THE DRAWINGS

FIG. 1 is a cross-sectional view of a motorcycle tire in accordance with an embodiment of the present disclosure;

FIG. 2 is a development view of a first carcass ply and a second carcass ply;

FIG. 3 is a development view of the first carcass ply; and

FIG. 4 is a development view of a band ply of FIG. 1.

### DETAILED DESCRIPTION OF THE INVENTION

Hereinafter, an embodiment of the present disclosure will be described with reference to the drawings.

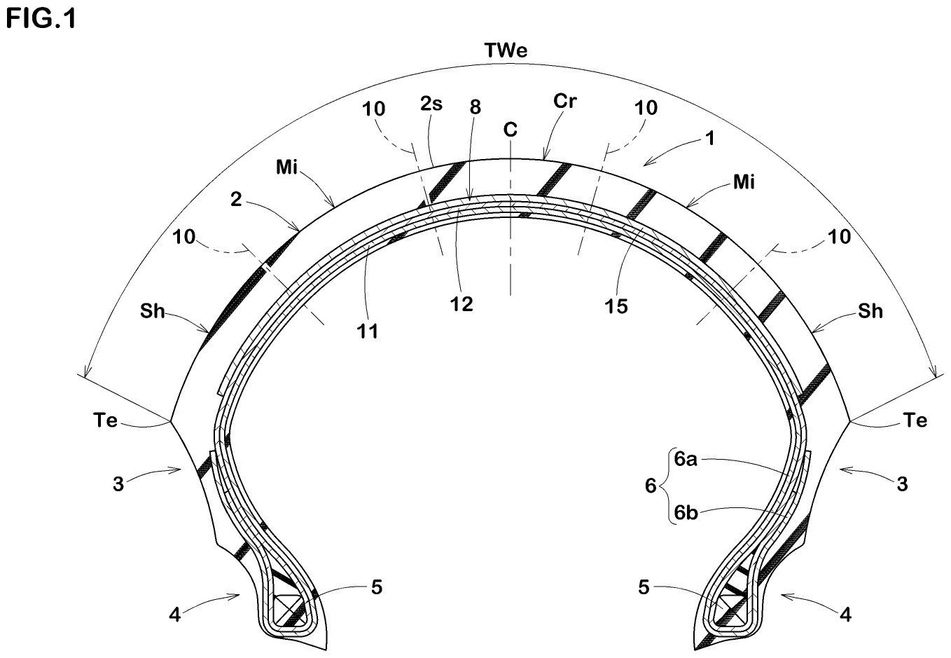

FIG. 1 is a cross-sectional view including the tire axis of a motorcycle tire 1 (hereafter, simply referred to as “tire”) under a normal state in accordance with an embodiment of the present disclosure. The tire 1 according to the present embodiment is a tire for front wheel of motorcycle suitable for on-road sport driving. However, the tire according to the present invention is not limited to such an aspect.

As used herein, when a motorcycle tire is based on a standard, “normal state” is such that the tire 1 is mounted onto a standard wheel rim with a standard pressure but loaded with no tire load. As used herein, when a motorcycle tire is not based on any standards, “normal state” means a standard usage state according to the purpose of use of the tire, where the tire is not mounted to a vehicle and loaded with no tire load. As used herein, unless otherwise noted, dimensions of portions of the tire 1 are values measured under the normal state.

As used herein, the “standard wheel rim” is a wheel rim officially approved for each tire by standards organizations on which the tire is based, wherein the standard wheel rim is the “standard rim” specified in JATMA, the “Design Rim” in TRA, and the “Measuring Rim” in ETRTO, for example.

As used herein, the “standard pressure” is a standard pressure officially approved for each tire by standards organizations on which the tire is based, wherein the standard pressure is the “maximum air pressure” in JATMA, the maximum pressure given in the “Tire Load Limits at Various Cold Inflation Pressures” table in TRA, and the “Inflation Pressure” in ETRTO, for example.

As illustrated in FIG. 1, the tire 1 according to the present embodiment includes a tread portion 2 between a pair of tread edges Te, a pair of sidewall portions 3, and a pair of bead portions 4. The tread portion 2 includes an outer surface 2s between the pair of tread edges Te. The outer surface 2s is curved in an arc-shaped manner protruding outwardly in the tire radial direction so that a sufficient grounding area can be maintained even when turning with a large camber angle. Note that the pair of tread edges Te corresponds to the axially both edges of the ground contacting surface of the tread portion 2 when turning at the maximum camber angle.

The tread portion 2 includes a crown region Cr, a pair of shoulder regions Sh and a pair of middle regions Mi. The crown region Cr is the central region when the tread development width TWe between the pair of tread ends Te is equally divided into five regions in the tire axial direction. The pair of shoulder regions Sh includes the pair of tread edges Te. and is the pair of regions on both sides of the tread portion 2 in the tire axial direction when equally divided into the five regions. The pair of middle regions Mi is located between the crown region Cr and each of the shoulder regions Sh. The boundaries 10 of the regions extend so as to divide the tread development width TWe into five regions equally when the tread portion 2 is developed in a plane. On the other hand, in the tire meridian cross-sectional view, the boundaries 10 extend in the normal direction of the tread portion 2 with respect to the outer surface 2s.

In addition, the tire 1 according to the present embodiment includes a toroidal carcass 6. The carcass 6 extends between the pair of bead portions 4 through the pair of sidewall portions 3 and the tread portion 2. The carcass 6 includes at least one carcass ply having a plurality of carcass cords coated with a topping rubber. The carcass 6 according to the present disclosure has a bias structure in which the carcass cords are obliquely with respect to the tire circumferential direction. The carcass cords, for example, are made of an organic fiber cord.

The carcass 6 according to the present embodiment, for example, includes a first carcass ply 11 and a second carcass ply 12 which are superimposed with each other. In the present embodiment, the first carcass ply 11 is located inwardly in the tire radial direction with respect to the second carcass ply 12 in the tread portion 2. In addition, the carcass 6 according to the present embodiment includes a main portion 6a and a pair of turn-up portions 6b. The main portion 6a extends between a pair of bead cores 5 of the pair of bead portions 4, through the tread portion 2 and the sidewall portions 3. Each of the turn-up portions 6b is connected to the main portion 6a and is turned up around a respective one of the bead cores 5 so as to extend outwardly in the tire radial direction.

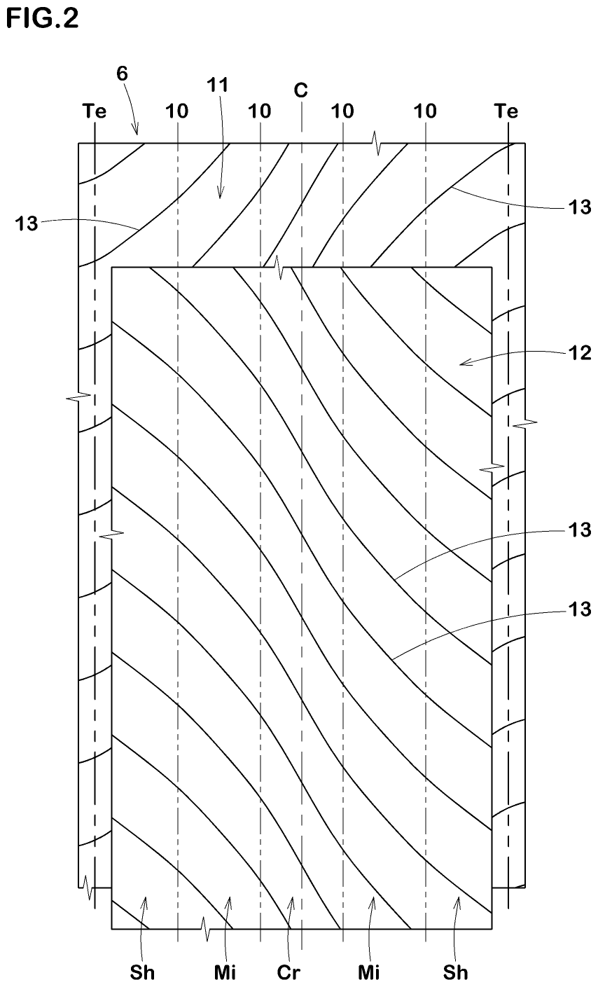

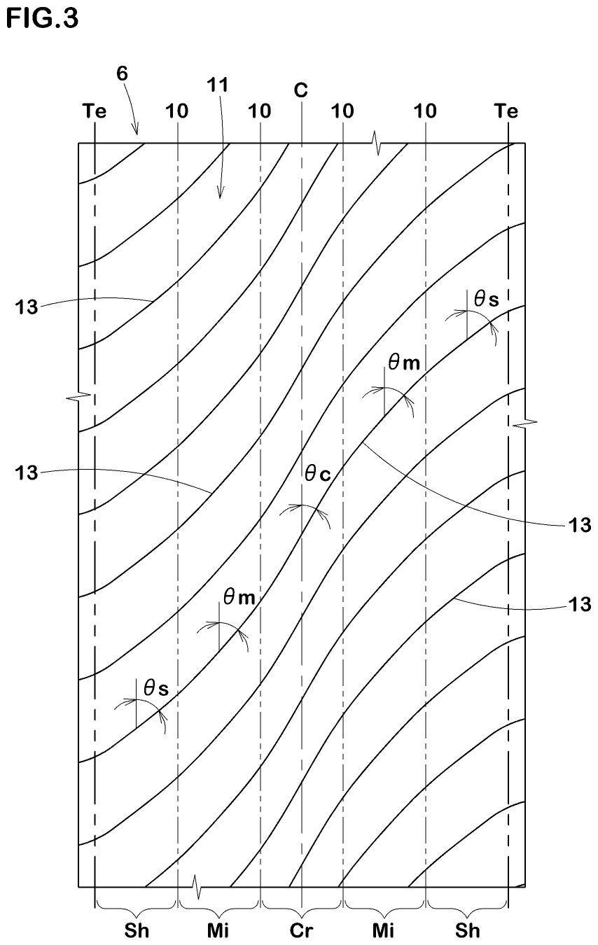

FIG. 2 illustrates a development view of the first carcass ply 11 and the second carcass ply 12, and FIG. 3 illustrates a development view of the first carcass ply 11 to show an arrangement of the carcass cords 13. As illustrated in FIGS. 2 and 3, in the present embodiment, the carcass cords 13 of the first carcass ply 11 are inclined in the first direction (upward to the right in each Figure of the embodiment) with respect to the tire axial direction, and the carcass cords 13 of the second carcass ply 12 are inclined in the second direction opposite to the first direction (downward to the right in each Figure of the embodiment) with respect to the tire axial direction. Thus, the first carcass ply 11 and the second carcass ply 12 are superimposed such that the carcass cords 13 cross with each other.

As illustrated in FIG. 3, an angle θs with respect to the tire circumferential direction of at least one of the plurality of carcass cords 13 in the shoulder regions Sh is greater than an angle θc with respect to the tire circumferential direction of at least one of the plurality of carcass cords 13 in the crown region Cr. By adopting the above configuration, the tire 1 according to the present disclosure can exhibit excellent turning performance. The reason for this is considered to be the following mechanism.

The arrangement of the above-mentioned the carcass cords 13 can enhance rigidity in the tire axial direction of the shoulder regions Sh. Thus, in a process of grounding from the crown region Cr to either one of the shoulder regions Sh when turning, the camber thrust and cornering force can increase gradually and when either one of the shoulder regions Sh comes into contact with the ground, a sufficiently large camber thrust and cornering force can be obtained. On the other hand, the above-mentioned small angle of the carcass cords in the crown region Cr can enhance rigidity in the tire circumferential direction of the crown region Cr, maintaining braking performance. In the present disclosure, it is considered that excellent turning performance can be exhibited by the above mechanism.

Hereinafter, a more detailed configuration of the present embodiment will be described. Note that each configuration described below shows a specific aspect of the present embodiment. Thus, the present disclosure can exert the above-mentioned effects even if the tire does not include the configuration described below. Further, if any one of the configurations described below is applied independently to the tire of the present disclosure having the above-mentioned characteristics, the performance improvement according to each additional configuration can be expected. Furthermore, when some of the configurations described below are applied in combination, it is expected that the performance of the additional configurations will be improved.

As illustrated in FIG. 3, in the crown region Cr, the middle regions Mi and the shoulder regions Sh, an angle with respect to the tire circumferential direction of the carcass cords 13 is preferably in a range of from 20 to 65 degrees.

In the crown region Cr, an angle θc with respect to the tire circumferential direction of the carcass cords 13, for example, is in a range of from 20 to 45 degrees, preferably 25 to 40 degrees. In addition, in the middle regions Mi, an angle θm with respect to the tire circumferential direction of the carcass cords 13, for example, is in a range of 25 to 60 degrees, preferably 30 to 55 degrees. In the shoulder regions Sh, an angle θs with respect to the tire circumferential direction of the carcass cords 13, for example, is in a range of 25 to 65 degrees, preferably 35 to 60 degrees. Note that the present disclosure is not limited to such angles.

Preferably, the angles with respect to the tire circumferential direction of the carcass cords 13 in the respective regions satisfy the relation of the following equation (1).

θc<θm<θs (1)

In addition, it is preferable that an angle of the carcass cords 13 increases continuously from the crown region Cr side toward each shoulder region Sh side. As a result, the response when a motorcycle body is leaned becomes linear, and handling performance can be improved.

The angle θc of the carcass cords 13 in the crown region Cr is preferably equal to or more than 0.35 times of the angle θs of the carcass cords 13 in the shoulder regions Sh, more preferably equal to or more than 0.50 times, but preferably equal to or less than 0.90 times, more preferably equal to or less than 0.75 times. Such an arrangement of the carcass cords 13 can improve turning performance of the tire while preventing the leaning response from becoming heavy.

The angle θm of the carcass cords 13 in the middle regions Mi is preferably equal to or more than 0.75 times of the angle θs of the carcass cords 13 in the shoulder regions Sh, more preferably equal to or more than 0.80 times, but preferably equal to or less than 0.98 times, more preferably equal to or less than 0.95 times. Such an arrangement of the carcass cords 13 can provide excellent handling performance when turning at a relatively large camber angle where one of the middle regions Mi and the shoulder region Sh adjacent thereto come into contact with the ground.

Note that the arrangements of the carcass cords 13 described above are applied not only to the carcass cords 13 of the first carcass ply 11 shown in FIG. 3 but also to the carcass cords of the second carcass ply 12. Further, the angles of the carcass cords 13 in the above respective regions correspond to angles which are measured at the center position in the tire axial direction of the respective regions.

As illustrated in FIG. 1, the tread portion 2 according to the present embodiment further includes a band layer 8 extending in the crown region Cr, the pair of middle regions Mi and the pair of shoulder regions Sh. The band layer 8 includes a band ply 15 having band cords oriented at an angle equal to or less than 5 degrees with respect to the tire circumferential direction. In some more preferred embodiment, the band ply 15 according to the present embodiment is configured as ajointless band ply that has one or more band cord wound spirally.

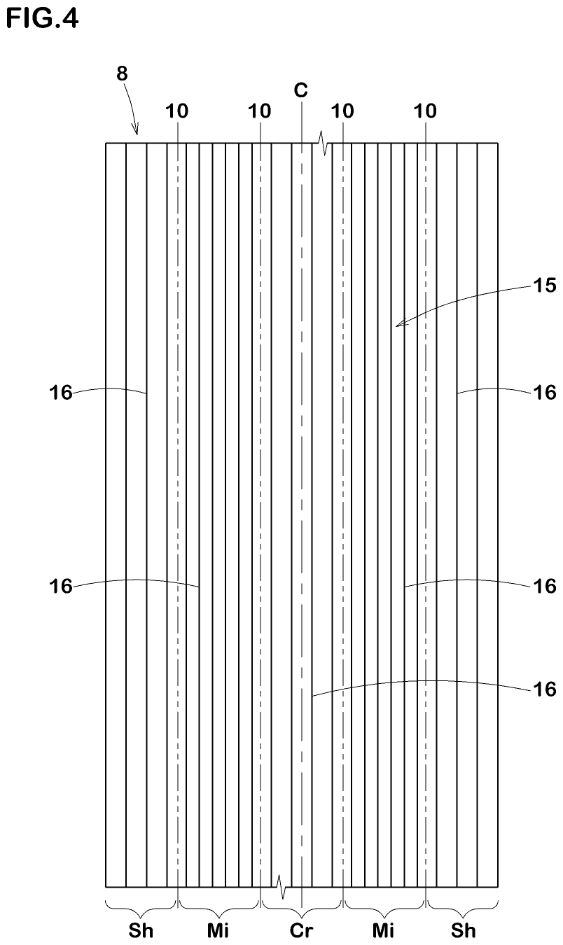

FIG. 4 is a development view of the band ply 15. In the present embodiment, ends of the band cords 16 of the band ply 15 (the number of cords arranged per 5 cm of the ply width in a tire cross-sectional view) are different for each region. This is expected to improve various performances.

Specifically, ends Ec of the band cords in the crown region Cr, for example, are in a range of from 10 to 40, preferably 20 to 35. Ends Em of the band cords in each middle region Mi, for example, are in a range of from 20 to 60, preferably 30 to 55. Ends Es of the band cords in each shoulder region Sh, for example, are in a range of from 5 to 40, preferably 10 to 35.

Preferably, the ends Em of the band cords 16 in each middle region Mi are greater than the ends Ec of the band cords 16 in the crown region Cr. Specifically, the ends Ec in the crown region Cr are preferably equal to or more than 0.50 times the ends Em in the middle regions Mi, more preferably equal to or more than 0.60 times, but preferably equal to or less than 0.90 times, more preferably equal to or less than 0.80 times.

The ends Es of the band cords 16 in each shoulder regions Sh are preferably smaller than the ends Em of the band cords 16 in each middle region Mi. Specifically, the ends Es in each shoulder region Sh are preferably equal to or more than 0.50 times the ends Em in the middle regions Mi, more preferably equal to or more than 0.60 times, but preferably equal to or less than 0.90 times, more preferably equal to or less than 0.80 times. Such an arrangement of the band cords 16 can relatively relax rigidity in the tire circumferential direction of the shoulder regions Sh and increase an area of the contact patch of the shoulder regions Sh, so that grip performance of the tire during turning can be improved.

As a result of various experiments, the inventor has found that the overall performance of the tire, such as the response when leaning a motorcycle, steering stability and turning performance can be improved by associating an angle of the carcass cords 13 with respect to the ends of the band cords 16.

Specifically, a value θc*Ec/Em obtained by multiplying the angle θc (shown in FIG. 3) of the carcass cords 13 in the crown region Cr by a ratio of the ends Ec of the band cords 16 in the crown region to the ends Em of the band cords 16 in each middle region Mi is preferably equal to or more than 10, more preferably equal to or more than 15, but preferably equal to or less than 55, more preferably equal to or less than 50. Such an arrangement of the carcass cords 13 and the band cord 16 can improve wear resistance, grip performance and turning performance in a well-balanced manner while maintaining steering stability in a turning condition where the camber angle is relatively small.

From a similar point of view, a value θs*Es/Em obtained by multiplying the angle θs (shown in FIG. 3) of the carcass cords 13 in each shoulder region Sh by a ratio of the ends Es of the band cords 16 in each shoulder region Sh to the ends Em of the band cords 16 in each middle region Mi is preferably equal to or more than 10, more preferably equal to or more than 15, but preferably equal to or less than 55, more preferably equal to or less than 50. Such an arrangement of the carcass cords 13 and the band cord 16 can improve wear resistance, grip performance and turning performance in a well-balanced manner while maintaining steering stability in a turning condition with a relatively large camber angle.

While the motorcycle tire of an embodiment of the present disclosure has been described in detail above, the present disclosure is not limited to the above-mentioned specific embodiment, and can be embodied by modifying to various aspects.

### Example

Motorcycle tires (for front wheel tire) with a nominal width of 120 mm, an aspect ratio of 70%, and a rim diameter of 17 inches, which have the basic structure of FIG. 1 were manufactured based on the specifications in Tables 1 to 4. In addition, as a comparative example, a tire was prototyped in which the angle of the carcass cords with respect to the tire circumferential direction was constant over the crown region, the middle regions and the shoulder regions. Note that the comparative example tire is practically the same as the tires of the examples, except for the above structure. Then, turning performance, grip performance, steering stability and wear resistance of each test tire were tested. The common specifications and test methods of each test tire are as follows.

Rim size: MT3.50

Tire inner pressure: 250 kPa

Test motorcycle displacement: 1000 cc

### Turning Performance, Grip Performance and Steering Stability Test:

The above test motorcycle ran a test course on a dry asphalt road surface, and each performance was evaluated. “Turning performance” refers to the overall turning performance from upright to full bank. “Grip performance” refers to the overall grip performance over the entire driving range. “Steering stability” refers to overall steering stability, including handling performance over the entire driving range. The test results are shown with a maximum score of 10 points, and the larger the value, the better each evaluation performance.

### Wear Resistance Test:

After traveling 15,000 km on a general road with the above test motorcycle, the remaining amount of tread rubber was measured. The test results are shown an index with the remaining amount of the comparative example as 100, and the larger the value, the more the remaining amount of tread rubber, more excellent wear resistance.

The test results are shown in Tables 1 to 4.

TABLE 1

| | Ref. | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Angle θc of carcass cords in Cr region (deg.) | 38 | 30 | 29 | 32 | 42 | 20 | 20 | 57 | 25 |
| Angle θm of carcass cords in Mi regions (deg.) | 38 | 42 | 35 | 44 | 43 | 39 | 21 | 60 | 26 |
| Angle θs of carcass cords in Sh regions (deg.) | 38 | 53 | 40 | 45 | 45 | 59 | 22 | 65 | 27 |
| Ends Ec of band cords in Cr region (ends/5 cm) | 39 | 31 | 19 | 30 | 31 | 32 | 15 | 39 | 12 |
| Ends Em of band cords in Mi regions (ends/5 cm) | 36 | 36 | 56 | 57 | 36 | 44 | 36 | 40 | 31 |
| Ends Es of band cords in Sh regions (ends/5 cm) | 40 | 32 | 40 | 12 | 29 | 7 | 32 | 39 | 10 |
| θc/θs | 1 | 0.57 | 0.73 | 0.71 | 0.93 | 0.34 | 0.91 | 0.88 | 0.93 |
| Ec/Em | 1.08 | 0.86 | 0.34 | 0.53 | 0.86 | 0.73 | 0.42 | 0.98 | 0.39 |
| Es/Em | 1.11 | 0.89 | 0.71 | 0.21 | 0.81 | 0.16 | 0.89 | 0.98 | 0.32 |
| θc * Ec/Em | 41.2 | 25.8 | 9.8 | 16.8 | 36.2 | 14.5 | 8.3 | 55.6 | 9.7 |
| θs * Es/Em | 42.2 | 47.1 | 28.6 | 9.5 | 36.3 | 9.4 | 19.6 | 63.4 | 8.7 |
| Turning performance (score) | 4.0 | 8.5 | 7.0 | 7.0 | 6.0 | 8.0 | 6.0 | 7.5 | 6.0 |
| Grip performance (score) | 4.0 | 8.5 | 7.5 | 7.0 | 8.0 | 7.0 | 7.5 | 6.5 | 6.5 |
| Steering stability (score) | 4.5 | 8.0 | 7.0 | 7.5 | 7.0 | 6.0 | 8.0 | 7.0 | 7.5 |
| Wear resistance (index) | 100 | 120 | 115 | 115 | 120 | 115 | 115 | 110 | 110 |

TABLE 2

| | Ex. 9 | Ex. 10 | Ex. 11 | Ex. 12 | Ex. 13 | Ex. 14 | Ex. 15 | Ex. 16 | Ex. 17 |
|---|---|---|---|---|---|---|---|---|---|
| Angle θc of carcass cords in Cr region (deg.) | 19 | 28 | 40 | 47 | 30 | 30 | 30 | 30 | 30 |
| Angle θm of carcass cords in Mi regions (deg.) | 36 | 40 | 46 | 50 | 42 | 42 | 42 | 42 | 42 |
| Angle θs of carcass cords in Sh regions (deg.) | 53 | 53 | 53 | 53 | 53 | 53 | 53 | 53 | 53 |
| Ends Ec of band cords in Cr region (ends/5 cm) | 31 | 31 | 31 | 31 | 16 | 18 | 23 | 28 | 34 |
| Ends Em of band cords in Mi regions (ends/5 cm) | 36 | 36 | 36 | 36 | 36 | 36 | 36 | 36 | 36 |
| Ends Es of band cords in Sh regions (ends/5 cm) | 32 | 32 | 32 | 32 | 32 | 32 | 32 | 32 | 32 |
| θc/θs | 0.36 | 0.53 | 0.75 | 0.89 | 0.57 | 0.57 | 0.57 | 0.57 | 0.57 |
| Ec/Em | 0.86 | 0.86 | 0.86 | 0.86 | 0.44 | 0.5 | 0.64 | 0.78 | 0.94 |
| Es/Em | 0.89 | 0.89 | 0.89 | 0.89 | 0.89 | 0.89 | 0.89 | 0.89 | 0.89 |
| θc * Ec/Em | 16.4 | 24.1 | 34.4 | 40.5 | 13.3 | 15 | 19.2 | 23.3 | 28.3 |
| θs * Es/Em | 47.1 | 47.1 | 47.1 | 47.1 | 47.1 | 47.1 | 47.1 | 47.1 | 47.1 |
| Turning performance (score) | 7.5 | 8.5 | 7.5 | 7.0 | 6.5 | 7.0 | 7.5 | 7.5 | 7.5 |
| Grip performance (score) | 8.5 | 8.5 | 8.5 | 8.0 | 7.0 | 8.0 | 8.5 | 8.5 | 7.0 |
| Steering stability (score) | 8.0 | 8.0 | 8.0 | 7.5 | 6.5 | 7.5 | 8.0 | 8.0 | 6.5 |
| Wear resistance (index) | 110 | 120 | 120 | 120 | 110 | 115 | 120 | 120 | 115 |

TABLE l

| | Ex. 18 | Ex. 19 | Ex. 20 | Ex. 21 | Ex. 22 | Ex. 23 | Ex. 24 | Ex. 25 | Ex. 26 |
|---|---|---|---|---|---|---|---|---|---|
| Angle θc of carcass cords in Cr region (deg.) | 30 | 30 | 30 | 30 | 30 | 20 | 30 | 40 | 60 |
| Angle θm of carcass cords in Mi regions (deg.) | 42 | 42 | 42 | 42 | 42 | 42 | 42 | 42 | 62 |
| Angle θs of carcass cords in Sh regions (deg.) | 53 | 53 | 53 | 53 | 53 | 53 | 53 | 53 | 64 |
| Ends Ec of band cords in Cr region (ends/5 cm) | 31 | 31 | 31 | 31 | 31 | 18 | 30 | 32 | 33 |
| Ends Em of band cords in Mi regions (ends/5 cm) | 36 | 36 | 36 | 36 | 36 | 36 | 36 | 36 | 36 |
| Ends Es of band cords in Sh regions (ends/5 cm) | 16 | 18 | 23 | 28 | 34 | 32 | 32 | 32 | 32 |
| θc/θs | 0.57 | 0.57 | 0.57 | 0.57 | 0.57 | 0.38 | 0.57 | 0.75 | 0.94 |
| Ec/Em | 0.86 | 0.86 | 0.86 | 0.86 | 0.86 | 0.5 | 0.83 | 0.89 | 0.92 |
| Es/Em | 0.44 | 0.5 | 0.64 | 0.78 | 0.94 | 0.89 | 0.89 | 0.89 | 0.89 |
| θc * Ec/Em | 25.8 | 25.8 | 25.8 | 25.8 | 25.8 | 10 | 25 | 35.6 | 55 |
| θs * Es/Em | 23.6 | 26.5 | 33.9 | 41.2 | 50.1 | 47.1 | 47.1 | 47.1 | 56.9 |
| Turning performance (score) | 8.0 | 8.0 | 8.5 | 8.5 | 8.0 | 7.5 | 8.0 | 8.0 | 7.0 |
| Grip performance (score) | 7.0 | 8.0 | 8.5 | 8.5 | 8.0 | 7.5 | 8.0 | 8.0 | 7.0 |
| Steering stability (score) | 7.0 | 7.5 | 7.5 | 7.5 | 7.0 | 7.0 | 7.5 | 7.5 | 6.5 |
| Wear resistance (index) | 110 | 120 | 120 | 120 | 110 | 110 | 120 | 120 | 110 |

TABLE 4

| | Ex. 27 | Ex. 28 | Ex. 29 | Ex. 30 |
|---|---|---|---|---|
| Angle θc of carcass cords in Cr region | 30 | 30 | 30 | 30 |
| (deg.) | | | | |
| Angle θm of carcass cords in Mi | 35 | 42 | 42 | 42 |
| regions (deg.) | | | | |
| Angle θs of carcass cords in Sh | 40 | 40 | 55 | 60 |
| regions (deg.) | | | | |
| Ends Ec of band cords in Cr region | 31 | 31 | 31 | 31 |
| (ends/5 cm) | | | | |
| Ends Em of band cords in Mi regions | 36 | 36 | 36 | 36 |
| (ends/5 cm) | | | | |
| Ends Es of band cords in Sh regions | 10 | 30 | 30 | 33 |
| (ends/5 cm) | | | | |
| θc/θs | 0.75 | 0.75 | 0.55 | 0.5 |
| Ec/Em | 0.86 | 0.86 | 0.86 | 0.86 |
| Es/Em | 0.28 | 0.83 | 0.83 | 0.92 |
| θc * Ec/Em | 25.8 | 25.8 | 25.8 | 25.8 |
| θs * Es/Em | 11.1 | 33.3 | 45.8 | 55 |
| Turning performance (score) | 6.5 | 8.0 | 8.0 | 7.0 |
| Grip performance (score) | 6.5 | 8.0 | 8.0 | 7.0 |
| Steering stability (score) | 7.0 | 7.5 | 7.5 | 7.0 |
| Wear resistance (index) | 110 | 120 | 120 | 115 |

As a result of the test, it is confirmed that the tires of the examples exhibit excellent turning performance. In addition, it is confirmed that the tires of the examples also improve grip performance, steering stability and wear resistance.

The following clauses are disclosed regarding the above-described embodiments.

### [Clause 1]

A motorcycle tire comprising:

a tread portion between a pair of tread edges;

a pair of sidewall portions;

a pair of bead portions; and

a carcass having a bias structure and extending between the pair of bead portions, wherein

the tread portion, when a tread development width between the pair of tread edges of the tread portion is equally divided into five regions, comprises a central crown region, a pair of shoulder regions including the pair of tread edges and a pair of middle regions located between the crown region and each of the shoulder regions,

the carcass comprises a plurality of carcass cords, and

an angle θs with respect to a tire circumferential direction of at least one of the plurality of carcass cords in the shoulder regions is greater than an angle θc with respect to the tire circumferential direction of at least one of the plurality of carcass cords in the crown region.

### [Clause 2]

The motorcycle tire according to clause 1, wherein

in the crown region, the pair of middle regions and the pair of shoulder regions, an angle with respect to the tire circumferential direction of the plurality of carcass cords is in a range of 20 to 65 degrees.

### [Clause 3]

The motorcycle tire according to clause 1 or 2, wherein

the angle θc is in a range of 0.35 to 0.90 times of the angle θs.

### [Clause 4]

The motorcycle tire according to any one of clauses 1 to 3, wherein

the tread portion is provided with a band layer extending in the crown region, the pair of middle regions and the pair of shoulder regions,

the band layer comprises a band ply having band cords oriented at an angle equal to or less than 5 degrees with respect to the tire circumferential direction, and

ends Em of the band cords in the middle regions is greater than ends Ec of the band cords in the crown region.

### [Clause 5]

The motorcycle tire according to clause 4, wherein

the ends Ec are in a range of from 0.50 to 0.90 times of the ends Em.

### [Clause 6]

The motorcycle tire according to clause 4 or 5, wherein

ends Es of the band cords of the band ply in each of the pair of shoulder regions are smaller than the ends Em.

### [Clause 7]

The motorcycle tire according to clause 6, wherein

the ends Es are in a range of from 0.50 to 0.90 times of the ends Em.

### [Clause 8]

The motorcycle tire according to any one of clauses 4 to 7, wherein

a value θc*Ec/Em obtained by multiplying the angle θc by a ratio of the ends Ec to the ends Em is in a range of 10 to 55.

### [Clause 9]

The motorcycle tire according to any one of any one of clauses 4 to 8, wherein

a value θs*Es/Em obtained by multiplying the angle θs by a ratio of ends Es of the band cords of the band ply in each of the pair of shoulder regions to the ends Em is in a range of 10 to 55.

### [Clause 10]

The motorcycle tire according to any one of clauses 4 to 9, wherein

the band ply comprises a jointless band ply having the band cords wound spirally.

1. A motorcycle tire comprising:
a tread portion between a pair of tread edges;
a pair of sidewall portions;
a pair of bead portions; and
a carcass having a bias structure and extending between the pair of bead portions, wherein
the tread portion, when a tread development width between the pair of tread edges of the tread portion is equally divided into five regions, comprises a central crown region, a pair of shoulder regions including the pair of tread edges and a pair of middle regions located between the crown region and each of the shoulder regions,
the carcass comprises a plurality of carcass cords, and
an angle θs with respect to a tire circumferential direction of at least one of the plurality of carcass cords in the shoulder regions is greater than an angle θc with respect to the tire circumferential direction of at least one of the plurality of carcass cords in the crown region.

2. The motorcycle tire according to claim 1, wherein
in the crown region, the pair of middle regions and the pair of shoulder regions, an angle with respect to the tire circumferential direction of the plurality of carcass cords is in a range of 20 to 65 degrees.

3. The motorcycle tire according to claim 1, wherein
the angle θc is in a range of 0.35 to 0.90 times of the angle θs.

4. The motorcycle tire according to claim 1, wherein
the tread portion is provided with a band layer extending in the crown region, the pair of middle regions and the pair of shoulder regions,
the band layer comprises a band ply having band cords oriented at an angle equal to or less than 5 degrees with respect to the tire circumferential direction, and
ends Em of the band cords in the middle regions is greater than ends Ec of the band cords in the crown region.

5. The motorcycle tire according to claim 4, wherein
the ends Ec are in a range of from 0.50 to 0.90 times of the ends Em.

6. The motorcycle tire according to claim 4, wherein
ends Es of the band cords of the band ply in each of the pair of shoulder regions are smaller than the ends Em.

7. The motorcycle tire according to claim 6, wherein
the ends Es are in a range of from 0.50 to 0.90 times of the ends Em.

8. The motorcycle tire according to claim 4, wherein
a value θc*Ec/Em obtained by multiplying the angle θc by a ratio of the ends Ec to the ends Em is in a range of 10 to 55.

9. The motorcycle tire according to claim 4, wherein
a value θs*Es/Em obtained by multiplying the angle θs by a ratio of ends Es of the band cords of the band ply in each of the pair of shoulder regions to the ends Em is in a range of 10 to 55.

10. The motorcycle tire according to claim 4, wherein
the band ply comprises a jointless band ply having the band cords wound spirally.

11. The motorcycle tire according to claim 1, wherein
an angle of the carcass cords increases continuously from the crown region to each shoulder region.

12. The motorcycle tire according to claim 1, wherein
the angle θc is in a range of 0.50 to 0.75 times of the angle θs.

13. The motorcycle tire according to claim 1, wherein
an angle θm of the at least one of the carcass cords in the middle regions is in a range of 0.75 to 0.98 times of the angle θs.

14. The motorcycle tire according to claim 1, wherein
an angle θm of the at least one of the carcass cords in the middle regions is in a range of 0.80 to 0.95 times of the angle θs.

15. The motorcycle tire according to claim 1, wherein
the ends Ec of the band cords in the crown region are in a range of from 10 to 40, and
the ends Em of the band cords in each middle region are in a range of from 20 to 60.

16. The motorcycle tire according to claim 1, wherein
the ends Ec of the band cords in the crown region are in a range of from 20 to 35, and
the ends Em of the band cords in each middle region are in a range of from 30 to 55.

17. The motorcycle tire according to claim 6, wherein
the ends Es of the band cords in each shoulder regions are in a range of 0.50 to 0.90 times of the ends Em in the middle regions.

18. The motorcycle tire according to claim 8, wherein
a value θs*Es/Em obtained by multiplying the angle θs by a ratio of ends Es of the band cords of the band ply in each of the pair of shoulder regions to the ends Em is in a range of 10 to 55.

19. The motorcycle tire according to claim 4, wherein
a value θc*Ec/Em obtained by multiplying the angle θc by a ratio of the ends Ec to the ends Em is in a range of 15 to 50.

20. The motorcycle tire according to claim 4, wherein
a value θs*Es/Em obtained by multiplying the angle θs by a ratio of ends Es of the band cords of the band ply in each of the pair of shoulder regions to the ends Em is in a range of 15 to 50.
